(19) United States
(12) Patent Application Publication
(10) Pub. No.: US 2023/0036137 A1
(43) Pub. Date: Feb. 2, 2023

(54) PREDICTIVE TRACKING APPARATUS, PREDICTIVE TRACKING METHOD, AND COMPUTER-READABLE MEDIUM

(71) Applicant: Mitsubishi Electric Corporation, Tokyo (JP)

(72) Inventor: Toshihito IKENISHI, Tokyo (JP)

(73) Assignee: Mitsubishi Electric Corporation, Tokyo (JP)

(21) Appl. No.: 17/961,988

(22) Filed: Oct. 7, 2022

Related U.S. Application Data
(63) Continuation of application No. PCT/JP2020/020676, filed on May 26, 2020.

(51) Int. Cl. G01S 17/66; G01S 7/48; G01S 17/931

(52) U.S. Cl. CPC G01S 17/66; G01S 7/4802; G01S 17/931

(57) ABSTRACT

A mobile object detection unit (113) extracts a point cloud representing a mobile object present around a mobile entity from point cloud data obtained by LiDAR which performs measurements in surroundings of the mobile entity. A mobile object tracking unit (116) extracts, from the point cloud data, a point cloud in a range of a posterior distribution for a tracked object, the tracked object being a mobile object that is being tracked, and performs matching of the extracted point cloud against the point cloud of the mobile object.

### CROSS REFERENCE TO RELATED APPLICATIONS

This application is a Continuation of PCT International Application No. PCT/JP2020/020676 filed on May 26, 2020, which is hereby expressly incorporated by reference into the present application.

### TECHNICAL FIELD

The present disclosure relates to predictive tracking of mobile objects.

### BACKGROUND ART

A technique that tracks mobile objects by utilizing point clouds measured by LiDAR is known.

LiDAR is an abbreviation of Light Detection And Ranging.

In a technique disclosed in Patent Literature 1, own position is estimated by performing matching of point clouds of surrounding objects with the ICP algorithm. The moved positions of surrounding vehicles are also estimated using a prediction filter such as Kalman filter or Bayes estimation.

ICP is an abbreviation of Iterative Closest Point.

### CITATION LIST

### Patent Literature

Patent Literature 1: JP 2018-141716

### SUMMARY OF INVENTION

### Technical Problem

In conventional techniques, maximization of posterior probability is performed by predicting the movement of a target object with a prediction filter. This improves estimation accuracy.

However, estimation cannot be performed when there is no prior distribution and target objects for which prior distribution is given are limited to vehicles.

In addition, in maximization of the posterior probability, the posterior probability can lead to a local solution. When an object other than a vehicle is targeted, a value may not converge depending on how prior distribution is given, making prediction difficult.

Further, since the ICP algorithm is used on a wide range or on many targets, calculation cost will increase.

An object of the present disclosure is to enable improvement in the accuracy of predictive tracking of a mobile object while keeping calculation cost low.

### Solution to Problem

A predictive tracking apparatus of the present disclosure includes:

a mobile object detection unit to extract a point cloud representing a mobile object present around a mobile entity from point cloud data obtained by LiDAR which performs measurements in surroundings of the mobile entity; and

a mobile object tracking unit to extract, from the point cloud data, a point cloud in a range of a posterior distribution for a tracked object, the tracked object being a mobile object that is being tracked, and to perform matching of the extracted point cloud against the point cloud of the mobile object.

### Advantageous Effects of Invention

The present disclosure enables improvement in the accuracy of predictive tracking of a mobile object while keeping calculation cost low.

### BRIEF DESCRIPTION OF DRAWINGS

FIG. 1 is a configuration diagram of a predictive tracking system 200 in Embodiment 1.

FIG. 2 is a configuration diagram of a predictive tracking apparatus 100 in Embodiment 1.

FIG. 3 is a configuration diagram of a sensor group 180 in Embodiment 1.

FIG. 4 is a flowchart of a predictive tracking method in Embodiment 1.

FIG. 5 is a flowchart of the predictive tracking method in Embodiment 1.

FIG. 6 is a flowchart of the predictive tracking method in Embodiment 1.

FIG. 7 is a flowchart of the predictive tracking method in Embodiment 1.

FIG. 8 is an illustration related to a prediction filter in Embodiment 1.

FIG. 9 is an illustration related to predictive tracking in Embodiment 1.

FIG. 10 is an illustration related to the predictive tracking in Embodiment 1.

FIG. 11 is an illustration related to prior distribution and likelihood function with respect to the types of mobile objects in Embodiment 1.

FIG. 12 is an illustration related to prior distribution and likelihood function with respect to the directions of movement of mobile objects in Embodiment 1.

FIG. 13 shows an example of the sensor group 180 in Embodiment 1.

FIG. 14 is a configuration diagram of the predictive tracking apparatus 100 in Embodiment 2.

FIG. 15 is a hardware configuration diagram of the predictive tracking apparatus 100 in the embodiments.

### DESCRIPTION OF EMBODIMENTS

In embodiments and drawings, the same elements or corresponding elements are given the same reference signs. Description of elements with the same reference signs as those of previously described elements are omitted or simplified as appropriate. Arrows in the drawings chiefly indicate flows of data or flows of processing.

### Embodiment 1

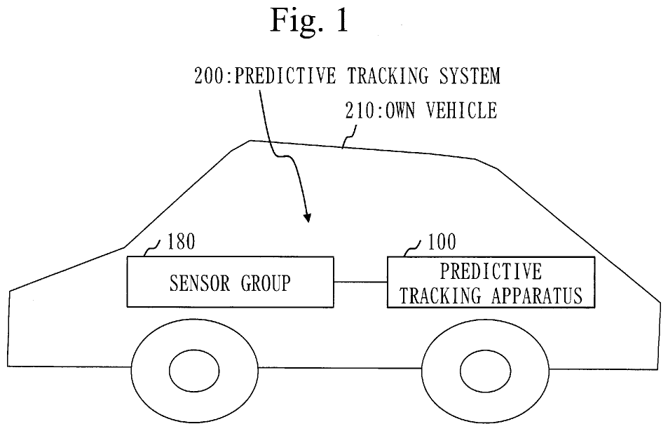

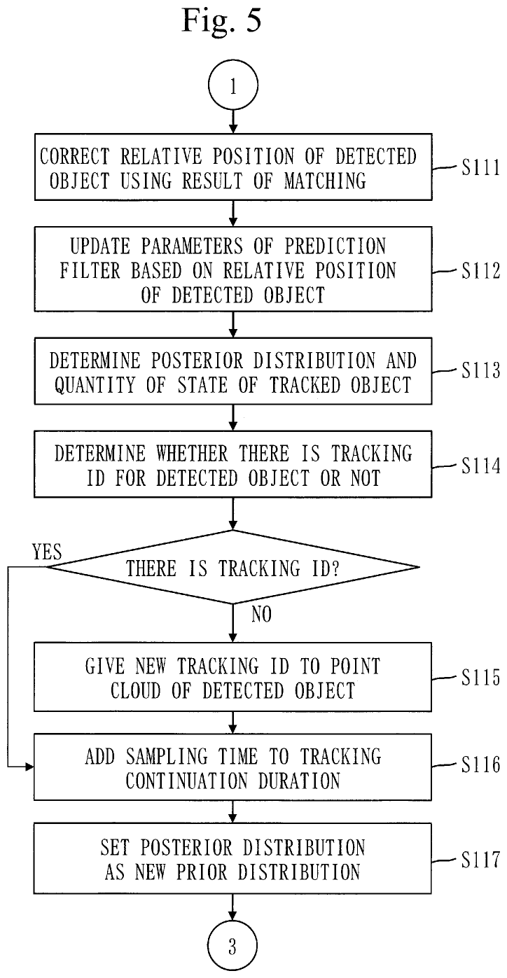

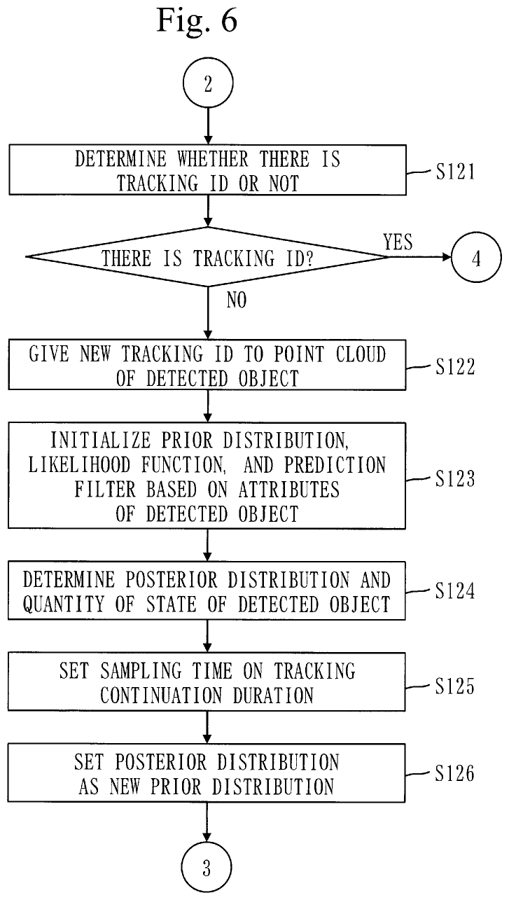

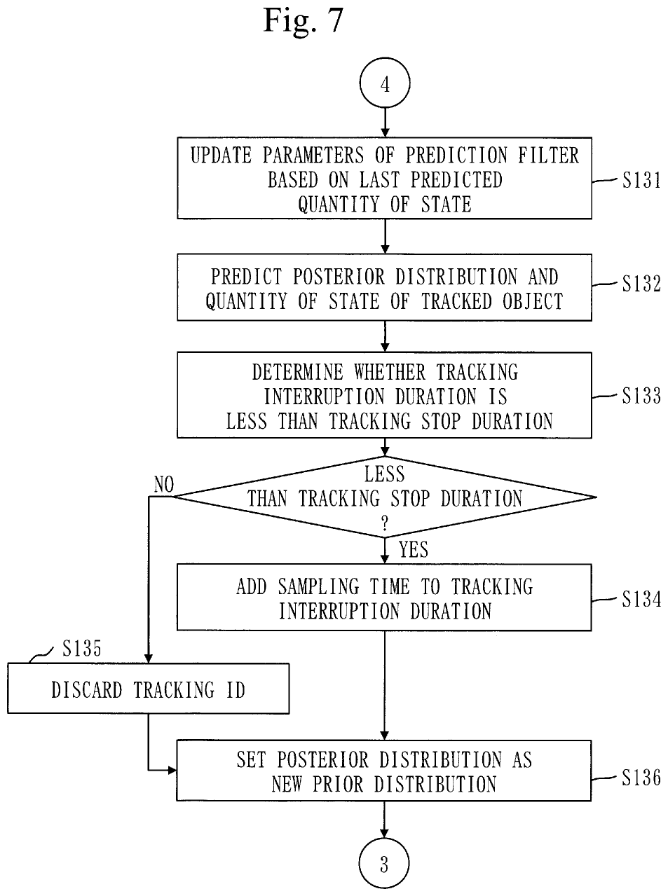

A predictive tracking system 200 is described based on FIGS. 1 to 13.

***Description of Configuration***

Based on FIG. 1, the configuration of the predictive tracking system 200 is described.

The predictive tracking system 200 is mounted on an own vehicle 210.

The own vehicle 210 is an automobile on which the predictive tracking system 200 is mounted. An automobile is an example of a mobile entity.

The predictive tracking system 200 includes a predictive tracking apparatus 100 and a sensor group 180.

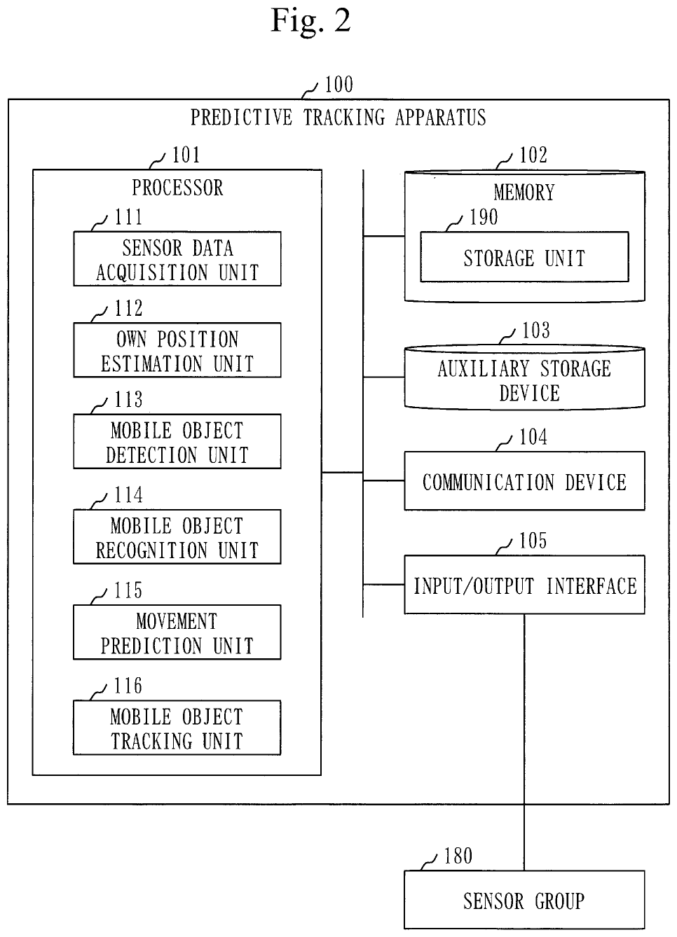

Based on FIG. 2, the configuration of the predictive tracking apparatus 100 is described.

The predictive tracking apparatus 100 is a computer equipped with pieces of hardware such as a processor 101, a memory 102, an auxiliary storage device 103, a communication device 104, and an input/output interface 105. These pieces of hardware are connected with each other via signal lines.

The processor 101 is an IC that performs arithmetic processing and controls other pieces of hardware. For example, the processor 101 is a CPU, a DSP, or a GPU.

IC is an abbreviation of Integrated Circuit.

CPU is an abbreviation of Central Processing Unit.

DSP is an abbreviation of Digital Signal Processor.

GPU is an abbreviation of Graphics Processing Unit.

The memory 102 is a volatile or non-volatile storage device. The memory 102 is also called a main storage device or main memory. For example, the memory 102 is RAM. Data stored in the memory 102 is saved in the auxiliary storage device 103 as needed.

RAM is an abbreviation of Random Access Memory.

The auxiliary storage device 103 is a non-volatile storage device. For example, the auxiliary storage device 103 is a ROM, an HDD, or flash memory. Data stored in the auxiliary storage device 103 is loaded to the memory 102 as needed.

ROM is an abbreviation of Read Only Memory.

HDD is an abbreviation of Hard Disk Drive.

The communication device 104 is a receiver and transmitter. For example, the communication device 104 is a communication chip or a NIC.

NIC is an abbreviation of Network Interface Card.

The input/output interface 105 is a port to which an input device, an output device, and the sensor group 180 are connected. For example, the input/output interface 105 is a USB terminal, the input device is a keyboard and a mouse, and the output device is a display.

USB is an abbreviation of Universal Serial Bus.

The predictive tracking apparatus 100 includes components such as a sensor data acquisition unit 111, an own position estimation unit 112, a mobile object detection unit 113, a mobile object recognition unit 114, a movement prediction unit 115, and a mobile object tracking unit 116. These components are implemented in software.

The auxiliary storage device 103 has stored therein a predictive tracking program for causing a computer to function as the sensor data acquisition unit 111, the own position estimation unit 112, the mobile object detection unit 113, the mobile object recognition unit 114, the movement prediction unit 115, and the mobile object tracking unit 116. The predictive tracking program is loaded to the memory 102 and executed by the processor 101.

The auxiliary storage device 103 further has an OS stored therein. At least part of the OS is loaded to the memory 102 and executed by the processor 101.

The processor 101 executes the predictive tracking program while executing the OS.

OS is an abbreviation of Operating System.

Input and output data for the predictive tracking program is stored in a storage unit 190.

The memory 102 functions as the storage unit 190. However, a storage device such as the auxiliary storage device 103, a register in the processor 101, or cache memory in the processor 101 may function as the storage unit 190 in place of the memory 102 or in conjunction with the memory 102.

The predictive tracking apparatus 100 may include multiple processors replacing the processor 101. The multiple processors share the functions of the processor 101.

The predictive tracking program can be recorded (stored) on a non-volatile recording medium such as an optical disk or flash memory in a computer readable manner.

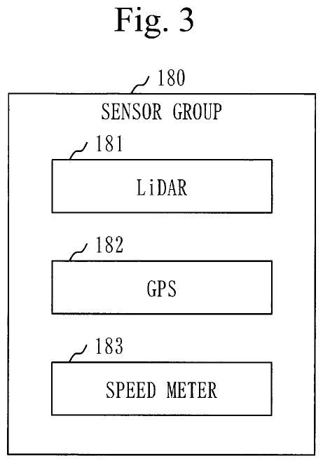

Based on FIG. 3, the configuration of the sensor group 180 is described.

The sensor group 180 includes sensors such as a LiDAR 181, a GPS 182, and a speed meter 183.

An example of the LiDAR 181 is a laser scanner. The LiDAR 181 emits laser light in different directions, receives incident laser light reflected at different points, and outputs point cloud data. The point cloud data indicates a distance vector and a reflection strength for each point at which laser light was reflected. LiDAR is an abbreviation of Light Detection and Ranging.

The GPS 182 is an example of a positioning system. The GPS 182 receives positioning signals, determines the own position, and outputs positioning data. The positioning data indicates position information. The position information indicates three-dimensional coordinate values. GPS is an abbreviation of Global Positioning System.

The speed meter 183 measures the speed of the own vehicle 210 and outputs speed data. The speed data indicates the speed of the own vehicle 210.

***Description of Operation***

A procedure of operation of the predictive tracking apparatus 100 corresponds to the predictive tracking method. The procedure of the operation of the predictive tracking apparatus 100 corresponds to the procedure of processing by the predictive tracking program.

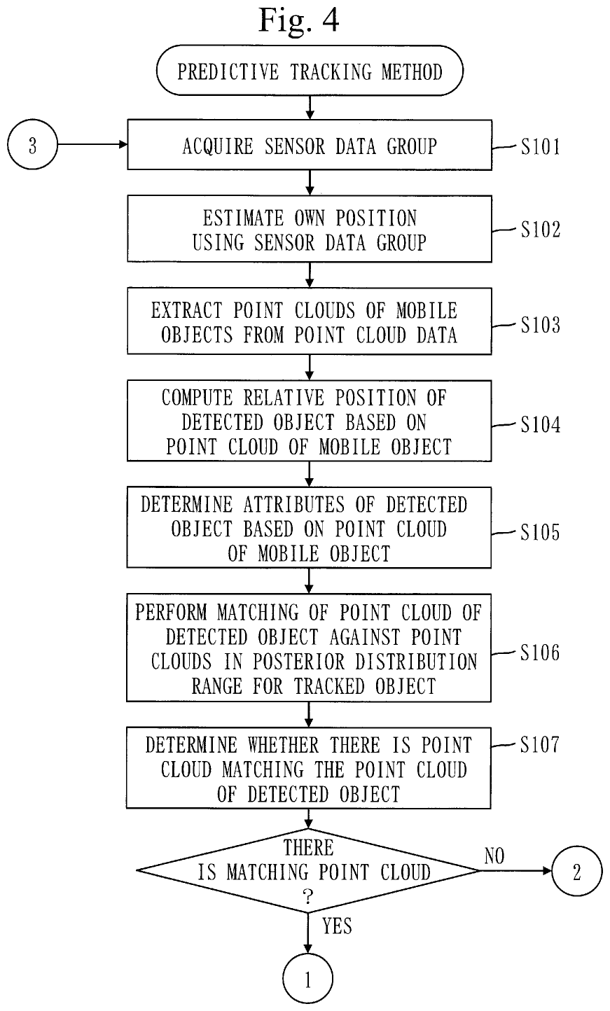

Based on FIGS. 4 to 7, the predictive tracking method is described.

In step S101, the sensor data acquisition unit 111 acquires a sensor data group from the sensor group 180.

The sensor group 180 is a set of sensors. The sensor data group is a set of sensor data. Sensor data is data obtained by the sensors.

The sensor data group includes sensor data such as point cloud data, positioning data, and speed data.

In step S102, the own position estimation unit 112 uses the sensor data group to estimate the position of the own vehicle 210. The position of the own vehicle 210 is referred to as “own position”.

For example, the own position estimation unit 112 computes an amount of movement using the speed indicated in the speed data and an elapsed time from the time of measurement. Then, the own position estimation unit 112 estimates the own position on the basis of the position information indicated in the positioning data and the computed amount of movement.

For example, the own position estimation unit 112 uses point cloud data to perform matching of point clouds of ground objects by a SLAM technique, and estimates the own position.

In step S103, the mobile object detection unit 113 extracts point clouds that represent mobile objects present around the own vehicle 210 from the point clouds indicated in the point cloud data.

A mobile object is an object that can move, such as an automobile. That is, both a traveling automobile and a stopped automobile represent mobile objects. However, mobile objects are not limited to vehicles.

Specifically, the mobile object detection unit 113 extracts a point cloud of a mobile object by means of machine learning, a rule-based technique, or deep learning.

In a rule-based technique, a point cloud of a road surface is first detected and point clouds of mobile objects are extracted from point clouds except the point cloud of the road surface.

A mobile object corresponding to an extracted point cloud is referred to as a “detected object”.

In step S104, the mobile object detection unit 113 computes a relative position of the detected object based on the point cloud of the mobile object.

The relative position of a detected object is the position of the detected object with respect to the own vehicle 210.

Specifically, the mobile object detection unit 113 selects one representative point from the point cloud of the mobile object and converts the distance vector of the representative point to three-dimensional coordinate values. The three-dimensional coordinate values resulting from the conversion indicate the relative position of the detected object.

In step S105, the mobile object recognition unit 114 determines attributes of the detected object based on the point cloud of the mobile object.

The attributes of a detected object include type, orientation, size, and the like. The type identifies the kind of the mobile object, such as truck, standard car, motorbike, bicycle, or pedestrian. The orientation means the heading of the mobile object and corresponds to the direction of movement. The size indicates width, depth, height, and the like.

Specifically, the mobile object recognition unit 114 determines the attributes of the mobile object by means of machine learning, a rule-based technique, or deep learning.

In step S106, the mobile object tracking unit 116 extracts point clouds in the range of posterior distribution for a tracked object from the point cloud data.

The tracked object is a mobile object that is being tracked, that is, the mobile object the predictive tracking apparatus 100 is tracking.

Posterior distribution will be discussed later.

The mobile object tracking unit 116 performs matching of the extracted point cloud against the point cloud of the detected object.

For example, the mobile object tracking unit 116 performs matching in accordance with the ICP algorithm. ICP is an abbreviation of Iterative Closest Point.

When there are multiple point clouds in the range of the posterior distribution, the mobile object tracking unit 116 performs matching in descending order of likelihood which is based on the posterior distribution.

In step S107, the mobile object tracking unit 116 determines whether there is any point cloud that matches the point cloud of the detected object among the point clouds in the range of the posterior distribution for the tracked object based on the result of matching.

When there is a point cloud matching the point cloud of the detected object, the processing moves on to step S111.

When there is no point cloud matching the point cloud of the detected object, the processing moves on to step S121.

In step S111, the mobile object tracking unit 116 corrects the relative position of the detected object computed in step S104 using the result of matching. That is, the mobile object tracking unit 116 computes an accurate relative position of the detected object.

An accurate relative position is represented by a set of relative distances (x, y, z) and rotation angles (θx, θy, θz).

In step S112, the movement prediction unit 115 updates the parameters of a prediction filter for the tracked object based on the relative position of the detected object.

A specific example of the prediction filter is the Kalman filter. The parameters of the Kalman filter are predicted values, the covariance of a state transition matrix, observation noise, and Kalman gain.

The predicted values and the covariance of the state transition matrix are updated in a prediction step of the Kalman filter based on the covariance of system noise and a Jacobian matrix of state transition.

The Kalman gain is updated in a measurement updating step of the Kalman filter by using the covariance of the state transition matrix and observation noise.

In a general Kalman filter, the Kalman gain is updated in the following manner. The relative position obtained in step S111 is referred to as an accurate relative position.

In the previous step S112, the movement prediction unit 115 predicts the current relative position of the detected object by computing the Kalman filter. The predicted relative position (predicted value) is referred to as a predictive relative position.

In the current step S112, the movement prediction unit 115 computes the difference between the accurate relative position and the predictive relative position. Then, the movement prediction unit 115 updates the Kalman gain using the computed difference.

When Bayes estimation is used as the prediction filter, the parameters of the prediction filter include the predicted values, hyperparameters, and the like. The hyperparameters are used for determining the distribution profile of the likelihood (probability distribution) of observation noise. The likelihood (probability distribution) of observation noise is updated by means of the EM algorithm or an approximation technique.

In step S113, the movement prediction unit 115 computes the posterior distribution for the tracked object using the prediction filter, the prior distribution, and the likelihood function for the tracked object.

Then, the movement prediction unit 115 predicts a quantity of state of the tracked object using the posterior distribution for the tracked object.

The predicted quantity of state is the quantity of state at which the posterior probability becomes maximum. The quantity of state at which the posterior probability becomes maximum is computed by maximum posterior probability estimation.

For example, the quantity of state can be a position, a speed, an acceleration, a yaw angle, a yaw rate, a size, or the like. The prior distribution, the likelihood function, and the posterior distribution are set for each quantity of state.

In step S114, the mobile object tracking unit 116 determines whether there is a tracking ID for the detected object or not.

When there is a tracking ID for the detected object, that tracking ID for the detected object continues to be used. The processing moves on to step S116.

When there is no tracking ID for the detected object, the processing moves on to step S115.

In step S115, the mobile object tracking unit 116 generates a new tracking ID for the detected object and gives the new tracking ID to the point cloud of the detected object.

In step S116, the mobile object tracking unit 116 adds a sampling time to a tracking continuation duration for the detected object.

The tracking continuation duration is the length of time for which the tracked object is being tracked. The initial value of the tracking continuation duration is zero seconds.

The sampling time is a time interval at which a sensor data group is acquired in step S101, for example.

In step S117, the mobile object tracking unit 116 sets the posterior distribution for the tracked object as a new prior distribution for the tracked object. This causes the posterior distribution for the tracked object to be used as the prior distribution for the tracked object in the processing at the next step S101 and subsequent steps.

After step S117, the processing moves on to step S101.

In step S121, the mobile object tracking unit 116 determines whether there is at least one tracking ID or not.

When there is a tracking ID, that tracking ID continues to be used. The processing moves on to step S131.

When there is no tracking ID, the processing moves on to step S122.

In step S122, the mobile object tracking unit 116 generates a new tracking ID for the detected object and gives the new tracking ID to the point cloud of the detected object. This makes the detected object be treated as a new tracked object.

In step S123, the mobile object tracking unit 116 initializes the prior distribution, the likelihood function, and the prediction filter for the detected object based on the attributes of the detected object.

In step S124, the mobile object tracking unit 116 predicts the quantity of state of the detected object using the prior distribution, the likelihood function, and the prediction filter for the detected object.

The method of prediction is the same as that in step S113.

In step S125, the mobile object tracking unit 116 sets a sampling time on the tracking continuation duration for the detected object.

In step S126, the mobile object tracking unit 116 sets the posterior distribution for the detected object as a new prior distribution for the detected object. This causes the detected object to be treated as the tracked object and the posterior distribution for the detected object to be used as the prior distribution for the detected object (the tracked object) in the processing at the next step S101 and subsequent steps.

After step S126, the processing moves on to step S101.

Step S131 and subsequent steps are described. In the description of step S131 and subsequent steps, the “tracked object” means the tracked object identified by the tracking ID that was found in step S121.

In step S131, the movement prediction unit 115 updates the parameters of the prediction filter for the tracked object based on the last predicted quantity of state of the tracked object.

In step S132, the movement prediction unit 115 predicts the quantity of state of the tracked object using the prior distribution, the likelihood function, and a prediction filter for the tracked object.

The method of prediction is the same as that in step S113.

In step S133, the mobile object tracking unit 116 determines whether a tracking interruption duration for the tracked object is less than a tracking stop duration.

The tracking interruption duration is the length of time for which tracking of the tracked object is suspended, corresponding to the length of time for which no point cloud of the tracked object is being detected.

The tracking stop duration is an upper limit on the tracking interruption duration and is predefined.

When the tracking interruption duration for the tracked object is less than the tracking stop duration, the processing moves on to step S134.

When the tracking interruption duration for the tracked object is equal to or greater than the tracking stop duration, the processing moves on to step S135.

In step S134, the mobile object tracking unit 116 adds a sampling time to the tracking interruption duration for the tracked object.

After step S134, the processing moves on to step S136.

In step S135, the mobile object tracking unit 116 discards the tracking ID for the tracked object. This results in the tracking of the tracked object being stopped.

After step S135, the processing moves on to step S136.

In step S136, the mobile object tracking unit 116 sets the posterior distribution for the tracked object as a new prior distribution for the tracked object. This causes the posterior distribution for the tracked object to be used as the prior distribution for the tracked object in the processing at the next step S101 and subsequent steps.

After step S136, the processing moves on to step S101.

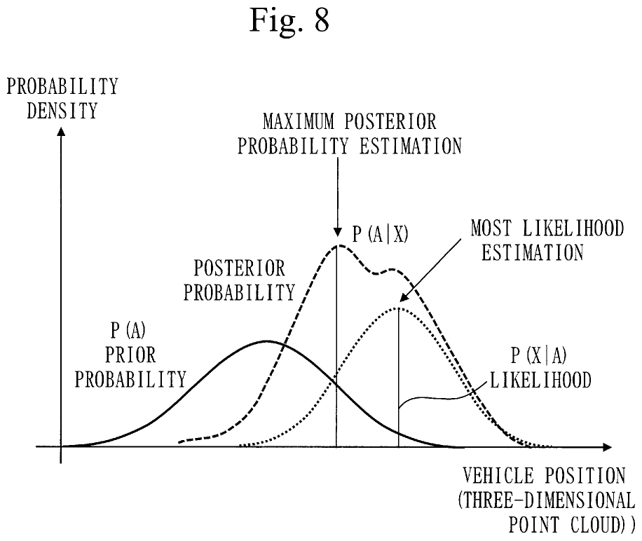

Based on FIG. 8, Bayes estimation as an example of the prediction filter is described.

The movement prediction unit 115 uses Bayes estimation, for example, to predict a future position of a mobile object.

FIG. 8 represents a simple example of Bayes estimation. The horizontal axis indicates the position of a vehicle as an example of a mobile object. The vertical axis indicates the probability density of the vehicle being present at each position. Prior distribution P(A) represents the possibility that event A occurs. The event A corresponds to a quantity of state of the mobile object. The prior distribution is also called prior probability distribution.

Posterior distribution P(A|X) represents the possibility (conditional probability) that the event A occurs under the condition that event X occurred when the likelihood function was P(X|A). The event X corresponds to a quantity of state of the mobile object. Posterior distribution is also called posterior probability distribution.

As shown in FIG. 8, relative to the prior distribution P(A) and the likelihood function P(X|A), the posterior distribution P(A|X) forms a complicated profile.

In order to determine a vehicle position at which the posterior probability becomes maximum (an optimal solution), it is necessary to solve the optimal solution analytically or to perform calculation numerically.

The expression below indicates Bayes estimation. Sigma with the suffix “A” means the sum of all values for the event A.

The movement prediction unit 115 calculates the expression below to compute a predicted value A\hat{ }that maximizes the posterior distribution P(A|X) and the posterior distribution P(A|X). The initial values of the prior distribution P(A) and the likelihood function P(X|A) vary depending on the attributes of the mobile object.

$$P ( A \vert X ) = \frac{P ( X \vert A ) P ( A )}{{\sum }_{A} P ( X \vert A ) P ( A )} \qquad FORMULA 1$$

An optimal solution with which the posterior probability becomes maximum need to be determined analytically or numerically. Determining an optimal solution with which the posterior probability becomes maximum is called posterior probability maximization.

When the optimal solution is determined analytically, the prior distribution will be a conjugate prior distribution and a posterior distribution with the same distribution as the prior distribution can be derived. When the prior distribution is a conjugate prior distribution, it is possible to solve the optimal solution analytically. In this case, an approximation of the posterior probability can be determined using an approximation estimation scheme such as calculus of variation or the Laplace approximation.

When the optimal solution is determined numerically, an optimization problem need to be solved. For solving an optimization problem, the EM algorithm, the MCMC method, and the like are available.

In the EM algorithm, a derivative for the posterior distribution is not necessary. EM is an abbreviation of Expectation-Maximization.

The MCMC method is a kind of sampling method and approximates a distribution. MCMC is an abbreviation of Markov Chain Monte Carlo.

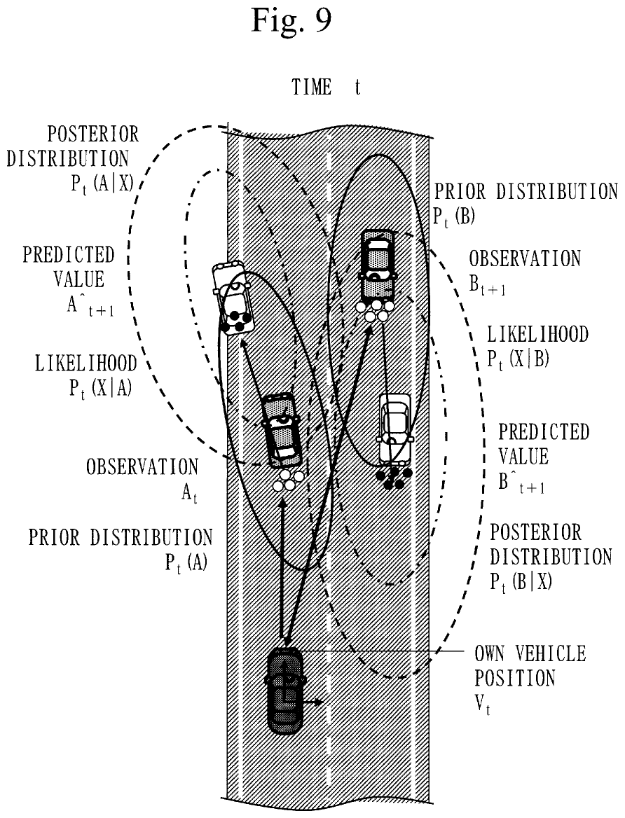

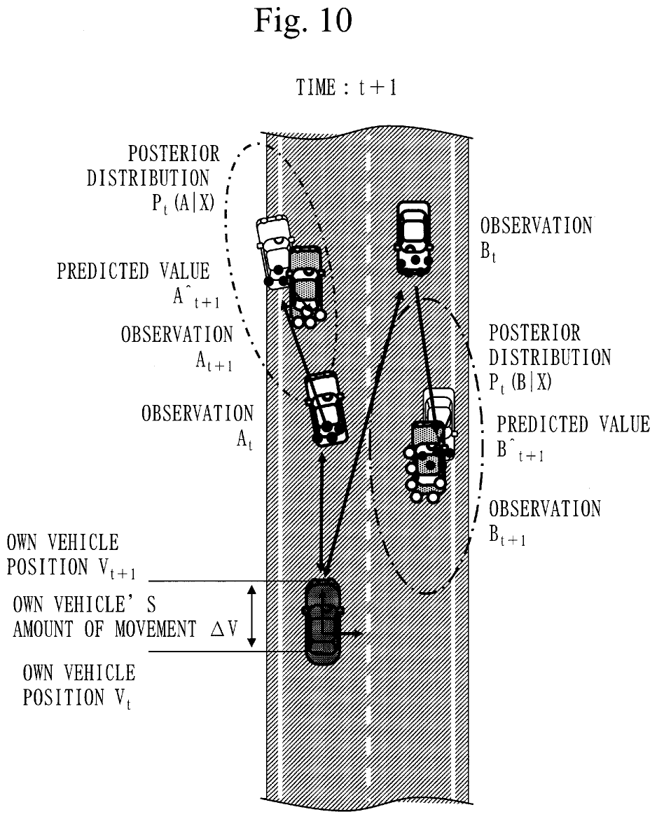

Based on FIGS. 9 and 10, operations of the movement prediction unit 115 and the mobile object tracking unit 116 are described. The solid line circles represent prior distributions, the dashed line circles represent likelihood functions, and the dot-dashed line circles represent posterior distribution.

An own vehicle position Vₜ at time t (see FIG. 9) is considered to be the origin (0, 0). If the amount of movement of the own vehicle is observable, the own vehicle's amount of movement ΔV from time t to time t+1 (see FIG. 10) is trivial. Here, the movement prediction unit 115 sets a prior distribution and a likelihood function for the mobile object of interest for prediction and determines the posterior distribution. With posterior probability maximization, the complicated profile of the posterior distribution can be addressed. By the predicted posterior distribution, the range of presence of the tracked target is defined. The mobile object tracking unit 116 performs matching of point clouds within the range of the posterior distribution. If there are matching point clouds, the mobile object tracking unit 116 performs tracking considering the matching point clouds to be the point cloud of the same object. The mobile object tracking unit 116 also computes an accurate amount of movement (relative distance) and an accurate attitude (rotation angle) of the mobile object with respect to the own vehicle. The computed amount of movement and attitude are observations.

In FIG. 9, the movement prediction unit 115 sets a prior distribution Pₜ(A) for a vehicle ahead of the own vehicle (mobile object A) and a prior distribution Pₜ(B) for a vehicle on the opposite lane (mobile entity B).

At the start of prediction (t=0), the movement prediction unit 115 sets the prior distribution Pₜ(A) and a likelihood function Pₜ(X|A) based on the attributes of the mobile object A.

At the start of prediction (t=0), the movement prediction unit 115 sets the prior distribution Pₜ(B) and a likelihood function Pₜ(X|B) based on the attributes of the mobile object B.

The prior distribution and the likelihood function based on the attributes of a mobile object will be discussed later.

In FIG. 10, the movement prediction unit 115 computes the position of the mobile object A at time t+1 (predicted value A\hat{ }ₜ₊₁) and a posterior distribution Pₜ(A|X) using the prior distribution Pₜ(A) and the likelihood function Pₜ(X|A).

The movement prediction unit 115 also computes the position of the mobile object B at time t+1 (predicted value B\hat{ }ₜ₊₁) and a posterior distribution Pₜ(B|X) using the prior distribution Pₜ(B) and the likelihood function Pₜ(X|B).

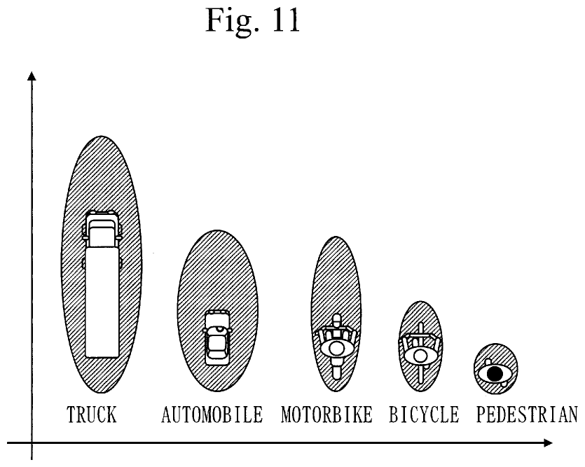

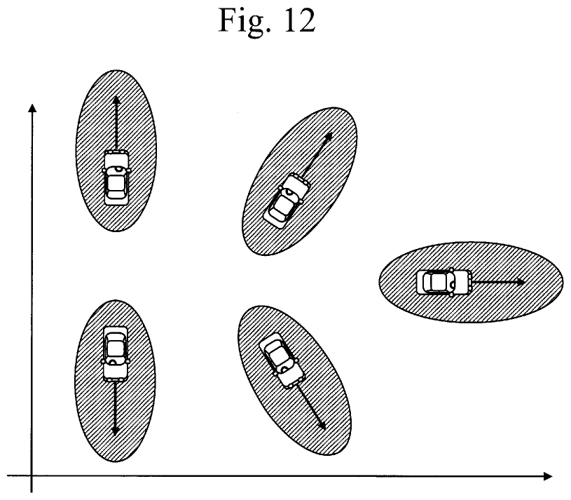

Based on FIGS. 11 and 12, the prior distribution and the likelihood function based on the attributes of a mobile object are described. The hatched portions represent prior distributions.

FIG. 11 visually represents prior distributions that vary depending on the type of the mobile object.

FIG. 12 visually represents prior distributions that vary depending on the direction of movement (heading) of the mobile object.

The likelihood function also similarly varies depending on the type, the direction of movement, and the like.

***Description of Examples***

The predictive tracking apparatus 100 may be installed outside the own vehicle 210 if it can acquire a sensor data group from the sensor group 180 on the own vehicle 210.

The sensor group 180 may be installed outside the own vehicle 210 if they can perform measurements on the own vehicle 210 and the surroundings of the own vehicle 210.

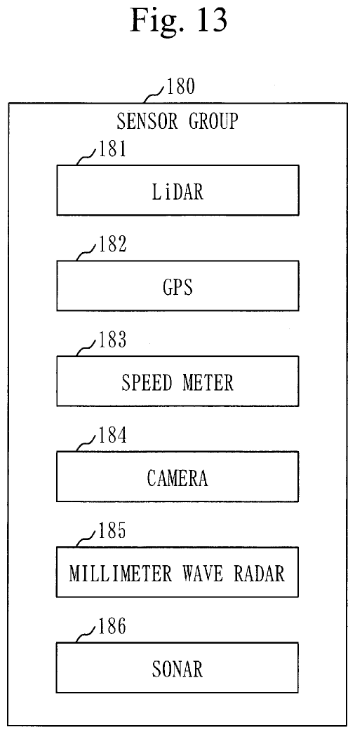

As shown in FIG. 13, the sensor group 180 may include sensors such as a camera 184, a millimeter wave radar 185, and a sonar 186.

The camera 184 captures the surroundings of the own vehicle 210 and outputs image data. The image data represents images showing the surroundings of the own vehicle 210. The camera 184 can be a stereo camera, for example.

The millimeter wave radar 185 outputs reflection distance data by utilizing a millimeter wave instead of laser light. Reflection distance data for the millimeter wave radar 185 indicates a distance for each point at which a millimeter wave was reflected.

The sonar 186 outputs reflection distance data by utilizing a sound wave instead of laser light. Reflection distance data for the sonar 186 indicates a distance for each point at which a sound wave was reflected.

By utilizing image data and reflection distance data, estimation of the own position can be performed with high accuracy.

It is also possible to estimate the own position using image data alone. For example, the own position estimation unit 112 estimates the own position by using image data acquired by a stereo camera. Alternatively, the own position estimation unit 112 estimates the own position by measuring distances from feature points in an image by Visual SLAM.

By utilizing image data and reflection distance data, it is possible to improve the accuracy of extracting point clouds of mobile objects and the accuracy of determining the attributes of the mobile objects.

Different prediction filters than the Kalman filter and the Bayes estimation may be used. For example, a known filter like a particle filter may be used. Alternatively, multiple filters may be used by being switched by IMM method. IMM is an abbreviation of Interacting Multiple Model.

Point cloud matching may be performed by means of an algorithm other than the ICP algorithm. For example, the NDT algorithm may be utilized. NDT is an abbreviation of Normal Distributions Transform.

The mobile object tracking unit 116 may evaluate the correctness of tracking using the tracking continuation duration. For evaluating the correctness of tracking, the tracking interruption duration may also be used in addition to the tracking continuation duration. The tracking continuation duration can serve as an indicator for checking for how much time the tracked object has been tracked correctly. The tracking interruption duration is the time of tracking processing which was repeated from when the tracked object got hidden by something to when it was observed again, for example.

The mobile object tracking unit 116 may determine the possibility that the tracked object is present at a predicted position of the tracked object using the tracking continuation duration.

***Effects of Embodiment 1***

The predictive tracking apparatus 100 can set the prior distribution for the mobile object in consideration of its type (truck, bus, car, bicycle, pedestrian, and the like) and direction of movement (heading) obtained from a result of recognition of the mobile object. This improves the prediction accuracy in tracking of the mobile object.

The predictive tracking apparatus 100 performs matching of point clouds with the ICP algorithm only within the range of the predicted posterior distribution. This achieves reduced calculation cost and precise measurements of the amounts of movement of other vehicles.

The predictive tracking apparatus 100 uses an approximation technique such as the Laplace approximation and the variational Bayesian method when determining a posterior distribution for posterior probability maximization. This improves the prediction accuracy in tracking of a mobile object.

The predictive tracking apparatus 100 can also detect a mobile object (extraction of point clouds), recognize it (determination of its attributes), and track it using only point cloud data from a sensor data group. That is, it is also possible to perform the detection, recognition, and tracking of a mobile object only using the LiDAR 181 out of the sensor group 180.

### Embodiment 2

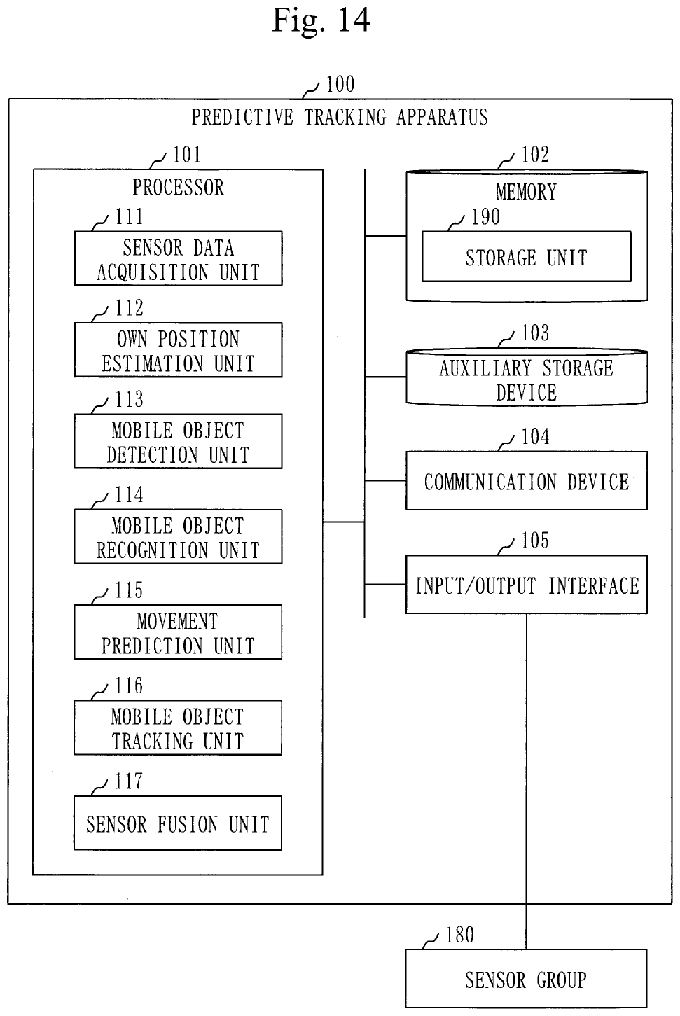

An embodiment that utilizes sensor fusion is described based on FIG. 14 focusing on differences from Embodiment 1.

***Description of Configuration***

Based on FIG. 14, the configuration of the predictive tracking apparatus 100 is described.

The predictive tracking apparatus 100 further includes a sensor fusion unit 117.

The predictive tracking program further causes a computer to function as the sensor fusion unit 117.

***Description of Operation***

The sensor fusion unit 117 performs sensor fusion using two or more kinds of sensor data included in the sensor data group.

Major methods for sensor fusion include ones for fusion of RAW data, fusion of intermediate data, and fusion of data after detection. All of these methods adopt an approach such as deep learning, and can extract point clouds of mobile objects and determine the attributes of the mobile objects with high accuracy compared to a case where a single kind of sensor data is used alone.

Types of sensor fusion include early fusion, cross fusion, and late fusion.

For combinations of sensors in sensor fusion, various combinations are conceivable, such as the camera 184 and the LiDAR 181, the LiDAR 181 and the millimeter wave radar 185, or the camera 184 and the millimeter wave radar 185.

The own position estimation unit 112 estimates the own position using data obtained by sensor fusion on two or more kinds of sensor data.

The mobile object detection unit 113 computes the relative position of the detected object based on data obtained by sensor fusion on two or more kinds of sensor data including point cloud data.

***Effects of Embodiment 2***

By utilizing sensor fusion, the detection, recognition, and tracking of a mobile object can be performed with higher accuracy.

***Additional Description of Embodiments***

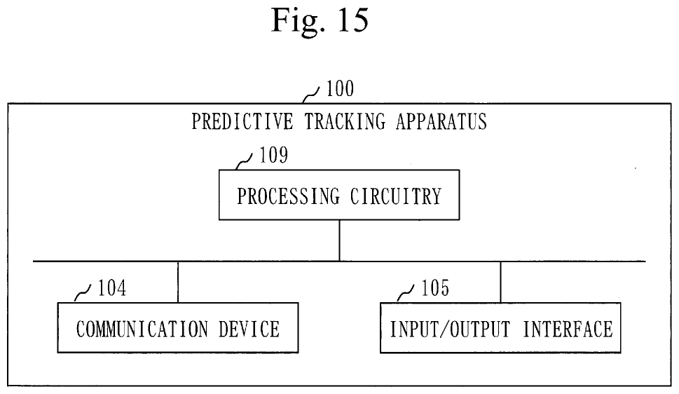

Based on FIG. 15, the hardware configuration of the predictive tracking apparatus 100 is described.

The predictive tracking apparatus 100 includes processing circuitry 109.

The processing circuitry 109 is a piece of hardware that implements the sensor data acquisition unit 111, the own position estimation unit 112, the mobile object detection unit 113, the mobile object recognition unit 114, the movement prediction unit 115, the mobile object tracking unit 116, and the sensor fusion unit 117.

The processing circuitry 109 may be dedicated hardware or may be the processor 101 that executes the program stored in the memory 102.

If the processing circuitry 109 is dedicated hardware, the processing circuitry 109 can be a single circuit, a composite circuit, a programmed processor, a parallel programmed processor, an ASIC, a FPGA, or combination of them, for example.

ASIC is an abbreviation of Application Specific Integrated Circuit.

FPGA is an abbreviation of Field Programmable Gate Array.

The predictive tracking apparatus 100 may include multiple processing circuits replacing the processing circuitry 109. The multiple processing circuits share the functions of the processing circuitry 109.

In the processing circuitry 109, some of its functions may be implemented in dedicated hardware and the remaining functions may be implemented in software or firmware.

Thus, the functions of the predictive tracking apparatus 100 can be implemented in hardware, software, firmware, or a combination of them.

Each embodiment is illustrative of a preferred embodiment and is not intended to limit the technical scope of the present disclosure. Each embodiment may be practiced partially or may be practiced in combination with other embodiments. The procedures described with flowcharts and the like may be modified as appropriate.

The “unit” as components of the predictive tracking apparatus 100 may also be read as “process” or “step”.

### REFERENCE SIGNS LIST

100: predictive tracking apparatus; 101: processor; 102: memory; 103: auxiliary storage device; 104: communication device; 105: input/output interface; 109: processing circuitry; 111: sensor data acquisition unit; 112: own position estimation unit; 113: mobile object detection unit; 114: mobile object recognition unit; 115: movement prediction unit; 116: mobile object tracking unit; 117: sensor fusion unit; 180: sensor group; 181: LiDAR; 182: GPS; 183: speed meter; 184: camera; 185: millimeter wave radar; 186: sonar; 190: storage unit; 200: predictive tracking system; 210: own vehicle

1. A predictive tracking apparatus comprising:
processing circuitry
to extract a point cloud representing a mobile object present around a mobile entity from point cloud data obtained by LiDAR which performs measurements in surroundings of the mobile entity;
to extract, from the point cloud data, a point cloud in a range of a posterior distribution for a tracked object, the tracked object being a mobile object that is being tracked, and to perform matching of the extracted point cloud against the point cloud of the mobile object;
to determine attributes of the mobile object based on the point cloud of the mobile object; and
to set a prior distribution and a likelihood function for the mobile object based on the attributes of the mobile object and to compute a posterior distribution for the mobile object using the prior distribution and the likelihood function for the mobile object.

2. The predictive tracking apparatus according to claim 1, wherein
the processing circuitry determines a type of the mobile object, and
sets the prior distribution and the likelihood function for the mobile object based on the type of the mobile object.

3. The predictive tracking apparatus according to claim 1, wherein
the processing circuitry determines a direction of movement of the mobile object, and
sets the prior distribution and the likelihood function for the mobile object based on the direction of movement of the mobile object.

4. The predictive tracking apparatus according to claim 1, wherein
the processing circuitry uses an approximate estimation scheme in determining an approximation of a posterior probability in posterior probability maximization.

5. The predictive tracking apparatus according to claim 2, wherein
the processing circuitry uses an approximate estimation scheme in determining an approximation of a posterior probability in posterior probability maximization.

6. The predictive tracking apparatus according to claim 3, wherein
the processing circuitry uses an approximate estimation scheme in determining an approximation of a posterior probability in posterior probability maximization.

7. The predictive tracking apparatus according to claim 2, wherein
the processing circuitry determines a direction of movement of the mobile object, and
sets the prior distribution and the likelihood function for the mobile object based on the direction of movement of the mobile object.

8. The predictive tracking apparatus according to claim 7, wherein
the processing circuitry uses an approximate estimation scheme in determining an approximation of a posterior probability in posterior probability maximization.

9. A predictive tracking method comprising:
extracting, a point cloud representing a mobile object present around a mobile entity from point cloud data obtained by LiDAR which performs measurements in surroundings of the mobile entity;
extracting, from the point cloud data, a point cloud in a range of a posterior distribution for a tracked object, the tracked object being a mobile object that is being tracked, and performing matching of the extracted point cloud against the point cloud of the mobile object;
determining, attributes of the mobile object based on the point cloud of the mobile object; and
setting a prior distribution and a likelihood function for the mobile object based on the attributes of the mobile object and to compute a posterior distribution for the mobile object using the prior distribution and the likelihood function for the mobile object.

10. A non-transitory computer-readable medium recorded with a predictive tracking program that causes a computer to execute:
a mobile object detection process of extracting a point cloud representing a mobile object present around a mobile entity from point cloud data obtained by LiDAR which performs measurements in surroundings of the mobile entity;
a mobile object tracking process of extracting, from the point cloud data, a point cloud in a range of a posterior distribution for a tracked object, the tracked object being a mobile object that is being tracked, and performing matching of the extracted point cloud against the point cloud of the mobile object;
a mobile object recognition process of determining attributes of the mobile object based on the point cloud of the mobile object; and
a movement prediction process of setting a prior distribution and a likelihood function for the mobile object based on the attributes of the mobile object and to compute a posterior distribution for the mobile object using the prior distribution and the likelihood function for the mobile object.
